(19) United States
(12) Patent Application Publication
(10) Pub. No.: US 2007/0247745 A1
(43) Pub. Date: Oct. 25, 2007

(54) Magnetic head and magnetic disk device

(75) Inventor: Hironori Teguri, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/511,802

(22) Filed: Aug. 29, 2006

(30) Foreign Application Priority Data
Apr. 24, 2006 (JP) 2006-119198

(51) Int. Cl. G11B 5/187

(52) U.S. Cl. 360/122

(57) ABSTRACT

As the surface of a main pole facing a magnetic disk, one with a rectangle-shaped part whose width in a radius direction consecutively changes in a direction orthogonal to the radius direction of the magnetic disk is adopted. The rectangle-shaped part has two sides facing each other in the orthogonal direction. Two angles formed by one of the two sides and two sides touching the side are different. One of the two angles is in the neighborhood of 90 degrees including 90 degrees. Adopting such a shape, a magnetic head capable of suppressing side write can be more easily fabricated.

### BACKGROUND OF THE INVENTION

1. Field of the Invention

The present invention relates to a magnetic head provided with a main pole for writing data on a rotary magnetic disk and a magnetic disk device provided with it.

2. Description of the Related Art

A magnetic disk device represented by a hard disk device continues to improve its recording density. A recording method for improving the recording density is shifting from a in-plane recording method of magnetizing a magnetic disk in its plane direction to a perpendicular magnetic recording method of perpendicularly magnetizing the disk. Currently a magnetic disk device adopting the perpendicular magnetic recording method is commercialized.

FIG. 1 shows the structure of a general magnetic disk device. The magnetic disk device is disclosed by Japanese Patent Application No. 2002-237142 (hereinafter “Patent reference 1”) As shown in FIG. 1, the magnetic disk device records or reproduces data by moving a magnetic head in the radius direction of a rotary magnetic disk 11. The magnetic head is mounted on the end 14 of a suspension arm 12 rotated around the center 13 by a voice coil motor (VCM) opposite to the magnetic disk 11.

Since the magnetic disk device usually adopts a rotary actuator for rotating the suspension arm 12, it has a skew angle which is formed by a recording track tangential direction due to the yaw angle of the suspension arm 12 and the magnetic head. The skew angle varies within a specific range, according to the yaw angle. For example, if the skew angle on the innermost circumference recording track and the skew angle on the outermost circumference recording track are θ1 and θ2, the skew angle varies within the range of θ1≦skew angle≦θ2.

In the perpendicular magnetic recording method, remarkable side write (protrusive record) in which a magnetic disk is magnetized with the main pole of a magnetic head projected from the track due to the skew angle occurs compared with the in-plane recording method. Since the width in the radius direction (side write width), magnetized projected from the track varies depending on the skew angle, it affects the determination of a track pitch, which is space with its adjacent track. Therefore, an optimal track pitch varies depending on the yaw angle, that is, its position in the radius direction.

As the magnetic head capable of suppressing the side write, one whose shape of the surface facing the magnetic disk, of the main pole is trapezoidal can be used, for example, as disclosed by K. Ito et al., “Current Progress of Single-pole type GMR Heads for Perpendicular Recording”, IEEE Trans. Magn., Vol. 38(1), pp. 175-180(2002) (hereinafter called “Non-patent reference 1”). FIG. 2 shows the shape of the surface of the main pole disclosed by Non-patent reference 1. The arrow mark A shown in FIG. 2 indicates the rotation direction of a magnetic disk (direction orthogonal to the radius direction of the magnetic disk, that is, corresponding to one of the recording track tangential directions). As shown in FIG. 2, in the shape of the surface, two angles (taper angles) α and β formed by a straight line orthogonal to the upper base, which is the longer one of two parallel sides, and two sides touching the upper base are not 0 degree. Thus, two upper base angles α′ and β′ formed by the upper base and the two sides are smaller than 90 degrees.

In the fabrication of a magnetic head, a member material is usually planed, for example, as disclosed by T. Okada et al., “Fabricating Narrow and Trapezoidal Main Poles for Single-pole type Heads”, IEEE Trans. Magn., Vol. 40, pp. 2329-2331 (2004) (hereinafter called “Non-patent reference 2”) and Y. Ikegawa et al., “A New Single-pole type Head Trimmed by Focuses Ion Beam at Wafer Level”, IEEE Trans. Magn., Vol. 40, pp. 2338-2340 (2004) (hereinafter called “Non-patent reference 3”). In processing the member material to a trapezoid, it must be planed from two directions different from when fabricating a rectangular main pole. In order to form a trapezoidal surface shown in FIG. 2, an ion beam must be applied to a member, for example, one width of which is larger than a pole length L and the other width of which is larger than a core width W from two directions to form taper angles α and β. Therefore, the fabrication process becomes complex. As disclosed by Patent reference 2, when fabricating a hexagonal main pole, its fabrication process becomes more complex.

The complex fabrication process incurs the degradation of the yield of the head fabrication. Therefore, it is preferable to further suppress the number of its fabrication processes. However, in order to further improve its recording density, side write must be suppressed. Thus, it is desired to easily fabricate a magnetic head while suppressing side write.

However, a track pitch which can be minimized according to its position in the radius direction varies depending on side write. From above reason, the track pitch varies depending on the skew angle. The recording capacity of a recording track varies depending on its position in the radius direction. Therefore, in order to improve the storage capacity of the entire device, it is also important to take into consideration its position where the skew angle becomes 0 degree.

### SUMMARY OF THE INVENTION

It is an object of the present invention to provide a magnetic head capable of being more easily fabricated and suppressing side write.

It is another object of the present invention to provide a magnetic disk device capable of more easily improving its data recording capacity.

Each of the magnetic heads in the first through third aspect of the present invention presumes the provision of a main pole for recording data on a rotary magnetic disk and is structured as follows.

In the magnetic head in the first aspect, the surface of a main pole, facing a magnetic disk has a rectangle-shaped part whose width in the radius direction consecutively changes in the direction orthogonal to the radius direction of the magnetic disk. The rectangular part has two sides facing each other in the orthogonal direction, and two angles formed by one of the two sides and two sides touching the side are different. One of the two angles is in the neighborhood of 90 degrees including 90 degrees.

It is preferable for the rectangle-shaped to be a trapezoid, the two sides facing each other in the orthogonal direction of which are parallel. It is preferable to form the angle in the neighborhood by a side located outside in the radius direction.

In the magnetic head in the second aspect, the surface of a main pole, facing a magnetic disk has a trapezoid-shaped part whose two sides facing each other in the direction orthogonal to the radius direction of the magnetic disk. The trapezoid-shaped part has a base, which is the shorter one of the two sides, and there is the size relationship between two angles formed by the base and two sides touching the base that an angle formed by a side located outside in the radius direction is smaller than an angle formed by a side located inside in the radius direction.

It is preferable for the angle formed by the side located outside to be in the neighborhood of 90 degrees including 90 degrees.

In the magnetic head in the second aspect, the surface of a main pole, facing a magnetic disk has a trapezoid-shaped part whose two sides facing each other in the direction orthogonal to the radius direction of the magnetic disk. In the trapezoid-shaped part, one of two angles formed by a base, which is the shorter of the two sides and two sides touching the base is in the neighborhood of 90 degrees including 90 degrees.

In the first through third aspects, it is preferable for the entire surface of the main pole to be trapezoidal-shaped.

The magnetic disk device of the present invention records data on a rotary magnetic disk. The magnetic disk device comprises a magnetic head with a main pole for recording data and a moving unit for moving the magnetic head in the radius direction of the magnetic disk. A position in the radius direction of the magnetic head whose skew angle, which is formed by a direction orthogonal to the radius direction of the magnetic disk, is 0 degree is within a third of an area extended toward the center from the outermost circumference of the magnetic disk.

It is preferable to adopt any of the magnetic heads of the first through third aspects as the magnetic head. It is preferable for a third of the area extended toward the center from the outermost circumference of the magnetic disk to be a third of the area extended from the outermost circumference of a range for writing data in the radius direction toward the inner most circumference of the range or an area in which the number of recording tracks for writing data counted from the outermost circumference is a third of the total.

In the present invention, a surface of a main pole, facing a magnetic disk has a rectangle-shaped part whose width in the radius direction consecutively changes in the direction orthogonal to the radius direction of the magnetic disk. The rectangle-shaped part has two sides facing each other in the orthogonal direction, and two angles formed by one of the two sides and two sides touching the side are different. One of the two angles is in the neighborhood of 90 degrees including 90 degrees. The rectangle-shaped part is, for example, a trapezoid-shaped part whose two sides facing each other in the direction orthogonal to the radius direction of the magnetic disk. One of two angles formed by a base, which is the shorter of the two sides and two sides touching the base is in the neighborhood of 90 degrees including 90 degrees. There is a size relationship that an angle formed by the side located inside in the radius direction, of the two sides is smaller in two angles formed by a base, which is the shorter of the two sides and two sides touching the base.

When adopting such a surface shape for the main pole, it becomes sufficient to plane a member material only from one direction different from when adopting the trapezoidal shape disclosed by Non-patent reference 1. Thus, the fabrication process can be simplified, thereby making the fabrication easier. The suppression of side write can also be made at the same level.

In the present invention, the position in the radius direction of the magnetic head whose skew angle, which is formed by a direction orthogonal to the radius direction of the magnetic disk, is 0 degree is within the a third of an area extended toward the center from the outermost circumference of the magnetic disk.

The recording capacity (line storage capacity) of the position (of the recording track) varies depending on its position in the radius direction. The further outside the magnetic disk the position is, the larger the capacity is. A width needed to record data varies depending on the skew angle. Usually, the smaller the absolute value of the skew angle, the smaller the width can be made. Thus, if the position in the radius direction whose skew angle becomes 0 degree is within a third of an area extended from the outermost circumference of the magnetic disk toward the center, the track density can be improved in an area with a larger line storage capacity. Thus, the data recording capacity of the entire device can be more easily improved. Since the above described magnetic head can suppress side write, the capacity can be further more easily improved by adopting such a magnetic head.

### BRIEF DESCRIPTION OF THE DRAWINGS

FIG. 1 shows the structure of a general magnetic disk device disclosed by Patent reference 1;

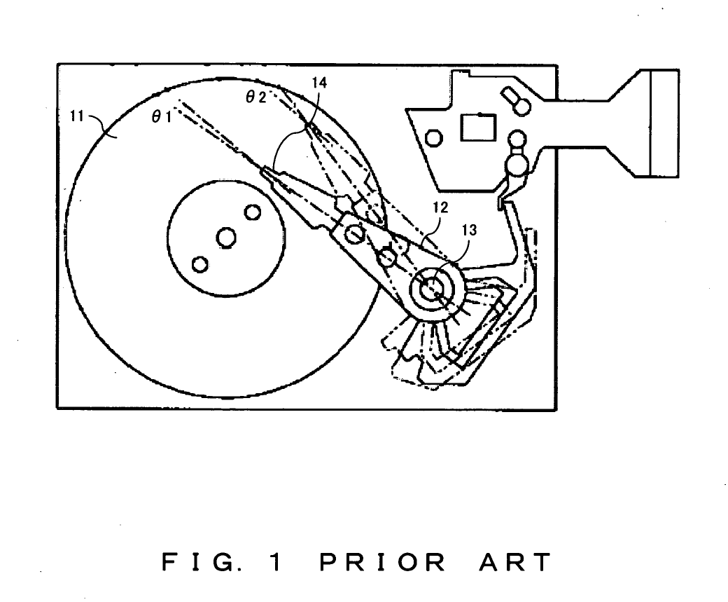

FIG. 2 shows the shape of the surface of a main pole disclosed by Non-patent reference 1;

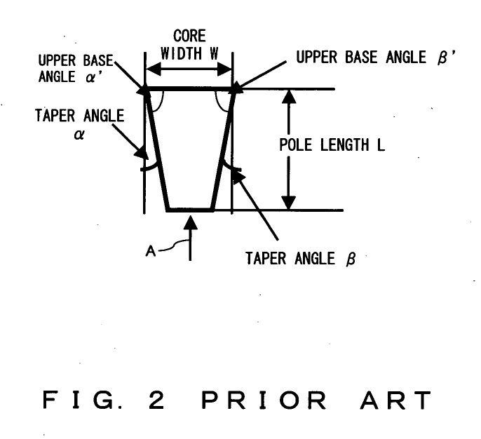

FIG. 3 shows the circuit configuration of the magnetic disk device in the preferred embodiment of the present invention;

FIG. 4 shows the shape of a suspension arm on which the magnetic head 32 is mounted;

FIG. 5 shows a slider mounted at the end of an arm 41;

FIG. 6 shows the structure of the magnetic head 32;

FIG. 7 shows the shape of the surface facing the magnetic disk 33, of a main pole 61a;

FIG. 8 is a graph showing an example of the yaw angle dependence of an optimal track pitch;

FIG. 9 is a graph showing another example of the yaw angle dependence of an optimal track pitch;

FIG. 10 is a graph showing the change of a storage capacity (line storage capacity) per cylinder according to a position in the radius direction;

FIG. 11 is a graph showing the difference of a track pitch according to a position in the radius direction;

FIG. 12 is a graph showing the relationship between the position whose skew angle becomes 0 degree and the storage capacity of the device;

FIG. 13 is the flowchart of a servo signal generation process; and

FIG. 14 is the flowchart of a positioning process.

### DESCRIPTION OF THE PREFERRED EMBODIMENTS

The preferred embodiments of the present invention are described in detail below with reference to the drawings.

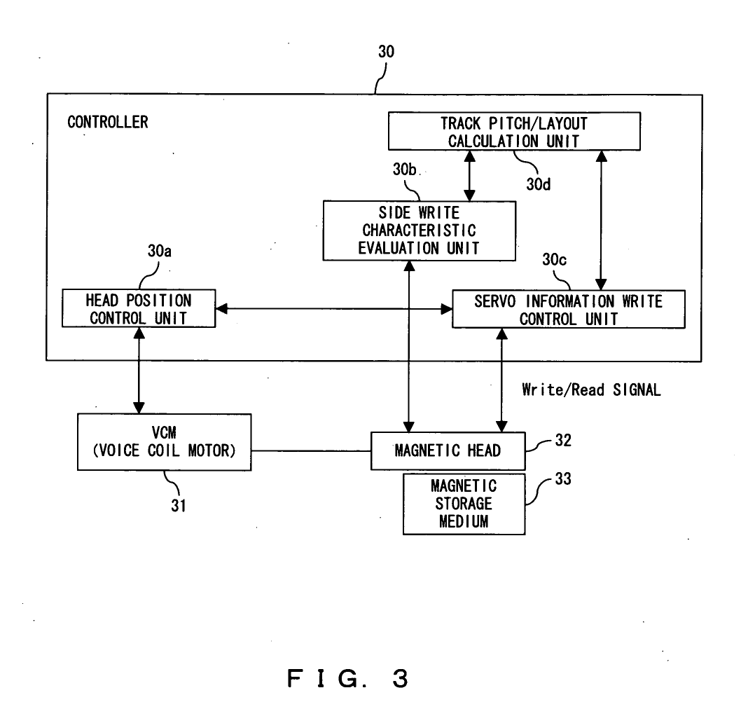

FIG. 3 shows the circuit configuration of the magnetic disk device in the preferred embodiment of the present invention.

As shown in FIG. 3, the magnetic disk device comprises a controller 30 for controlling the entire device, a voice coil motor (VCM) 31 driven by the controller 30, a magnetic head 32 and a magnetic storage medium (magnetic disk) 33 rotated by a motor, which is not shown in FIG. 3.

The controller 30 comprises a head position control unit 30a, a side write characteristic evaluation unit 30b, a servo information write control unit 30c and a track pitch/layout calculation unit 30d. Each of the units is as follows.

The head position control unit 30a drives/controls the VCM 31 to move the magnetic head 32 in the radius direction of the magnetic disk 33. The side write characteristic evaluation unit 30b evaluates (measures) its side write characteristic by recording data on the magnetic disk 33 by the magnetic head 32, reading the recorded data and analyzing it. The recorded data is read by finely moving its position in the radius direction by the head position control unit 30a. The track pitch/layout calculation unit 30d receives the evaluation result of the side write characteristic from the side write characteristic evaluation unit 30b and calculates an optimal track pitch for each position in the radius direction. The track pitch calculated for each position in the radius direction is a track pitch layout. The servo information write control unit 30c writes servo information on the magnetic disk 33 by the magnetic head 32, according to the track pitch calculated for each position in the radius direction by the track pitch/layout calculation unit 30d.

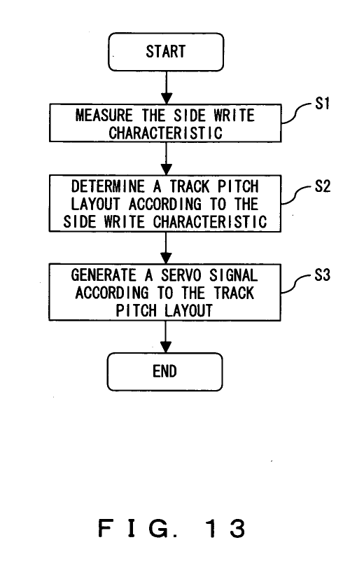

The evaluation (measurement) of a side write characteristic, the calculation of a track pitch and the writing of servo information are performed to initialize the magnetic disk 33. FIG. 13 is the flowchart of a servo signal generation process performed for the initialization. The measurement of a side write in step S1 is performed by the side write characteristic evaluation unit 30b. The determination of a track pitch layout according to the side write characteristic in step S2 is performed by the track pitch/layout calculation unit 30d. The generation of servo information (signal) on the magnetic disk 33 according to the track pitch layout in step S3 is performed by the servo information write control unit 30c. The units 30a through 30d including them can be actually realized by executing a program stored in ROM built in the controller 30.

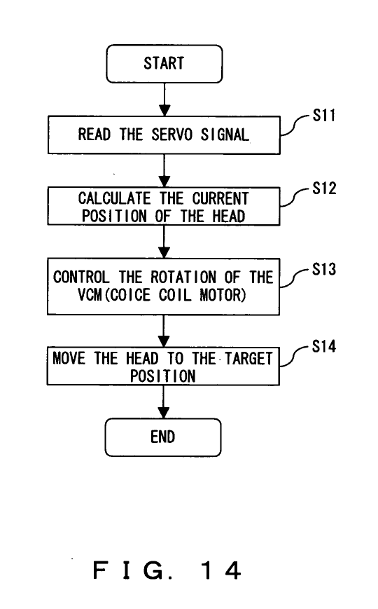

As the servo information, a track number, a sector number and the like are written in the magnetic disk 33. Thus, the writing of data or the positioning for moving the magnetic head 32 to a position to move in order to reproduce it can be realized by performing the positioning process shown in FIG. 14.

Firstly, in step S11, a servo signal is read by the magnetic head 32. In step S12, the current position of the magnetic head 32 is calculated based on the read servo information. In step S13, the rotation control of the VCM 31 is started in order to move the magnetic head 32 from the current position up to a target position to move. The movement is continued until the servo information of the target position is read. After the servo information is read, it is determined that the movement (positioning) of the magnetic head 32 is completed and the series of the processes terminate.

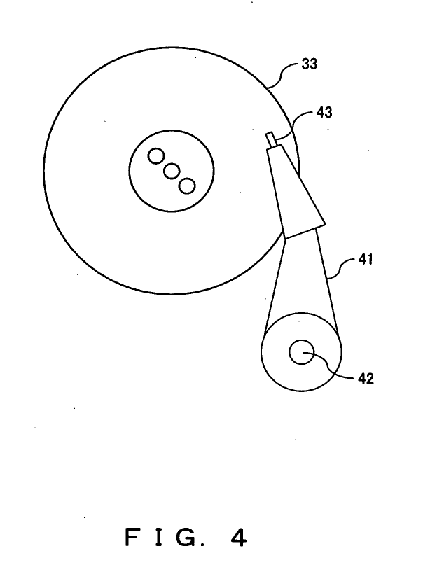

FIG. 4 shows the shape of a suspension arm on which the magnetic head 32 is mounted. The suspension arm (hereinafter called “arm”) 41 is driven/rotated around the center 42 by the VCM 31. The magnetic head 32 is mounted at the end 43 of the arm 41.

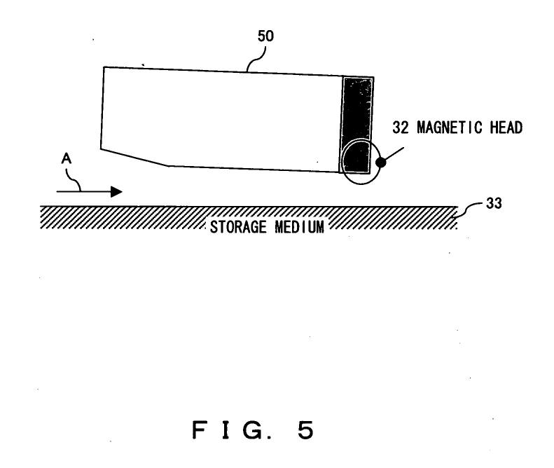

FIG. 5 shows a slider mounted at the end of the arm 41. As shown in FIG. 5, the magnetic head 32 is mounted at the end of a slider 50, that is, at the end on the far side when viewed from the rotation direction A of the magnetic disk 33.

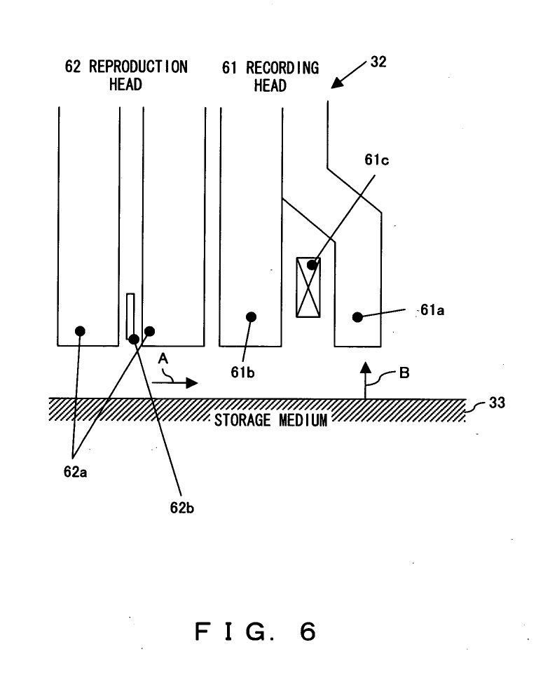

FIG. 6 shows the structure of the magnetic head 32. The magnetic head 32 comprises a recording head 61 for recording data and a reproduction head 62 for reproducing recorded data. The recording head 61 comprises a main pole 61a, an auxiliary pole 61b and a coil 61c for generating a magnetic field. The reproduction head 61b comprises two shields 62a and a magnetic resistor device 62b inserted between the two shields 62a. Data recorded on the magnetic disk 33 is read by the resistor device 62b.

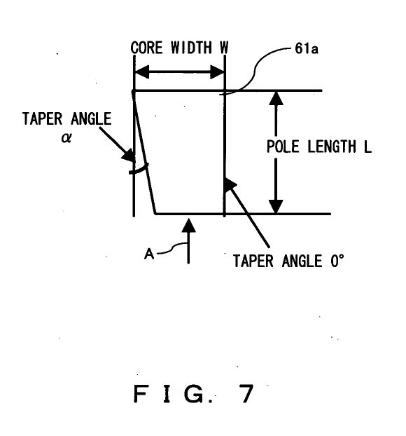

FIG. 7 shows the shape of the surface facing the magnetic disk 33, of the main pole 61a. The surface shape is obtained when viewed from the direction of the arrow B shown in FIG. 6.

As shown in FIG. 7, the surface shape is a trapezoid with two sides facing each other in the rotation direction A, that is, in the direction orthogonal to the radius direction of the magnetic disk 33. Taper angles formed by a straight line orthogonal to the longer one of two bases and two sides are 0 and a degrees, respectively. Thus, there is a size relationship in which two angles formed by the shorter one of the two bases and the two sides are 90 degrees and over 90 degrees, respectively. The side whose angle is 90 degrees is located inside in the radius direction of the magnetic disk 33.

It is because the surface on the side is not planed that one of the two angles is 90 degrees. In other words, it is because usually the main pole 61a is fabricated by planning a rectangular member. Thus, the angle can also depend on the shape of a member before being planed. Since usually the angle is 90 degrees, the actual angle becomes 90 degrees or in its neighborhood. The side surface whose angle is 90 degrees, of the two angles can also be located outside in the radius direction, that is, a side surface the reverse of this preferred embodiment.

The magnetic head 32 is mounted at an angle where the direction orthogonal to the radius direction of the magnetic disk 33 and a side the taper angle of the main pole 61a of which is a are parallel in the position whose skew angle becomes 0 degree or at an angle where the orthogonal direction becomes parallel to the side in a position further outside the position. The latter corresponds to the fact that an angle formed by the orthogonal direction and a straight line orthogonal to a base with a core width W in FIG. 7 is larger than the taper angle α. By mounting the magnetic head 32 thus, outside the position whose skew angle becomes 0 degree, a side located outside in the radius direction can be prevented from being located further outside than the base with core width W. On the side located inside, the side located inside in the radius direction can be prevented from being located further inside the base with core width W or a width projected from it can be suppressed at a minimum. Inside the position whose skew angle becomes 0 degree, the side located outside can be prevented from being further outside the base with core width W or a width projected from it can be suppressed at a minimum. On the side located inside, the side located inside in the radius direction can be prevented from being located further inside the base with core width W. thus, the side write of the entire radius direction can be suppressed.

The main pole 61a can be fabricated by planing only one side surface of a member. Therefore, compared with when planning the member from two directions, it can be more easily fabricated. Thus, the yield in the fabrication of the magnetic head 32 can be further improved.

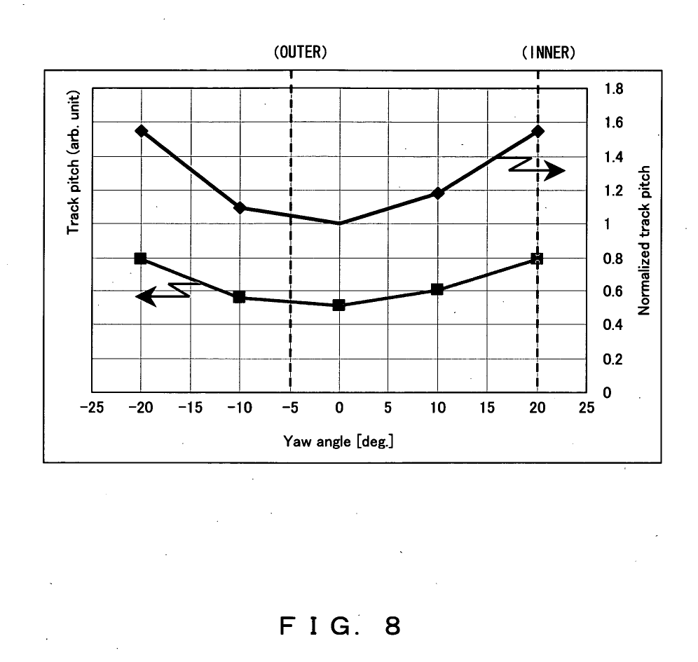

As shown in FIG. 4, in this preferred embodiment, the arm 41 is folded in the shape of a Japanese character “ [symbol] ” between the center 42 and the end 43. This is because the skew angle should be 0 degree in the outer magnetic disk 33. By adopting such a shape, even if the distance between the center 41 and the magnetic head 32 is short, the skew angle can be surely made 0 degree in the outer magnetic disk 33. A position in the radius direction, whose skew angle is 0 degree is made within a third of an area extended from the outermost circumference toward the center (rotation axis) of the magnetic disk 33. More specifically, a third of the area is an outer third of an area in a zone to record data or an area in which the number of recording tracks counted from the outermost circumference of the recording track is a third of the total. The reason why the skew angle should be 0 degree in such an area is described in detail below with reference to the drawings FIGS. 8 through 12.

FIG. 8 is a graph showing an example of the yaw angle dependence of an optimal track pitch. The horizontal axis indicates a yaw angle. The left- and right-side vertical axes indicate a track pitch in arbitrary unit and a normalized track pitch, respectively. As to a polygonal line located in the upper section, the right-side vertical axis indicates the change of an optimal track pitch by the yaw angle (skew angle). As to a polygonal line located under it, the left-side vertical axis indicates the change of an optimal track pitch by the yaw angle (skew angle). A track pitch is normalized to be 1 when the yaw angle is 0 degree.

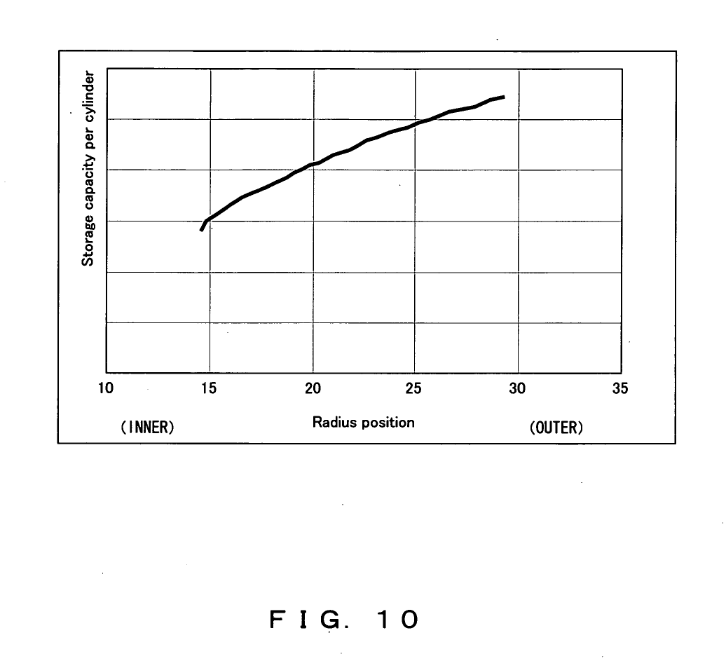

FIG. 10 is a graph showing the change of a storage capacity (line storage capacity) per cylinder according to a position in the radius direction. The horizontal and vertical axes indicate a position in the radius direction and a storage capacity, respectively.

The range of the yaw angle is determined based on the relationship between a position in the radius direction and a storage capacity per cylinder. As shown in FIG. 8, an optimal track pitch increases as the absolute value of the yaw angle increases. In other words, the optimal track pitch is minimized when the yaw angle is 0 degree, that is, the track density is maximized. The line storage capacity increases as the position in the radius direction is located further outside. Thus, a position whose yaw angle (skew angle) in which the track density is maximized becomes 0 degree is located outside in the radius direction. By increasing the track density in an area with a high line storage capacity, the storage capacity of the entire device can be effectively improved.

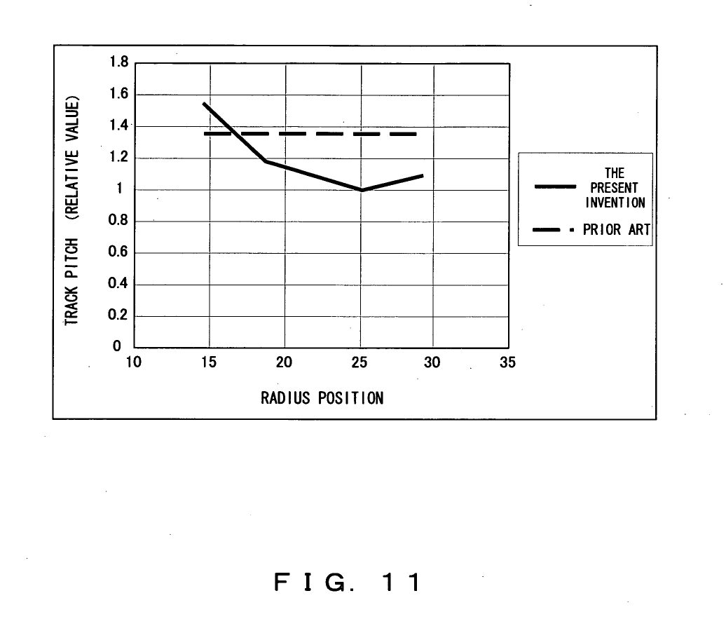

FIG. 11 is a graph showing the difference of a track pitch according to a position in the radius direction. The horizontal and vertical axes indicate a position in the radius direction and a track pitch (relative value), respectively. The relative value of a track pitch in a position whose yaw angle (skew angle) is 0 degree is normalized to be 1. As to the change in the radius direction of a track pitch, solid and broken lines indicate the preferred embodiment of the present invention and the prior art respectively.

Since a side write characteristic can be suppressed, as shown in FIG. 11, in this preferred embodiment, a track pitch is made to vary depending on a position in the radius direction assuming that a track pitch is optimized in a position in the radius direction. Thus, compared with the prior art in which a track pitch is constant, the track pitch is further narrowed in a position whose yaw angle (skew angle) is 0 degree and its neighborhood. Thus, the storage capacity of the entire device can also be greatly improved. As described above, a track pitch (track pitch layout) is determined by the track pitch/layout calculation unit 30d shown in FIG. 3.

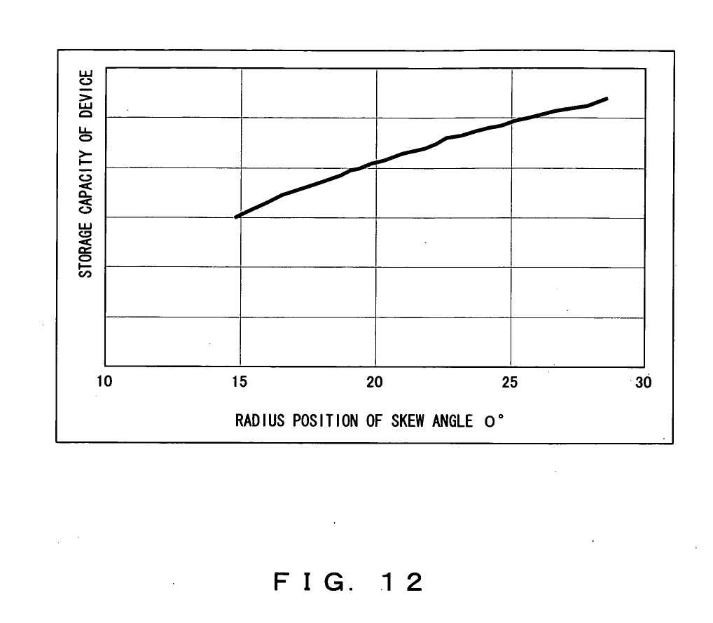

FIG. 12 is a graph showing the relationship between the position whose skew angle becomes 0 degree and the storage capacity of the device. The horizontal and vertical axes indicate a position in the radius direction, whose skew angle is 0 degree and the storage capacity of the entire device, respectively. As clearly seen from FIG. 12, by locating the position outside, the storage capacity of the entire device can be increased.

For the reason described above, it is preferable for the position in the radius direction, whose skew angle is 0 degree to be within a third of an area extended from the outermost circumference toward the center (rotation axis). By making the skew angle 0 degree in such an area, the storage capacity of the device can be more easily improved. Since by adopting the main pole 61a with the surface shape shown in FIG. 7, side write can be effectively suppressed, the storage capacity of the device can be more easily improved.

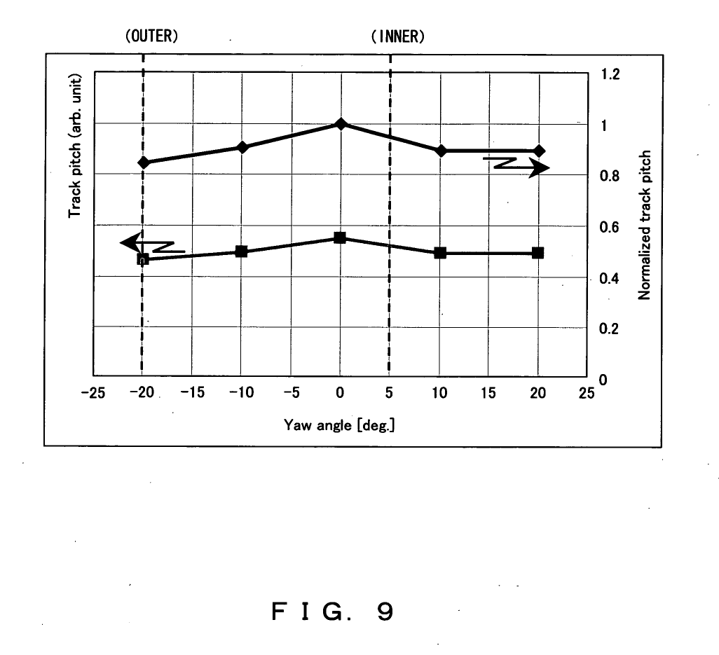

FIG. 9 is a graph showing another example of the yaw angle dependence of an optimal track pitch. As in FIG. 8, the horizontal axis indicates a yaw angle and the left- and right-side vertical axes indicate a track pitch in arbitrary unit and a normalized track pitch, respectively. As to one located in the upper section of two polygonal lines, the right-side vertical axis shows the change of an optimal track pitch by the yaw angle (skew angle). As to one located under it, the left-side vertical axis shows the change of an optimal track pitch by the yaw angle (skew angle).

Most of magnetic heads have the characteristic shown in FIG. 8. However, a part of them have the characteristic shown in FIG. 9. In the characteristic shown in FIG. 9, a track pitch by the position in the radius direction can be obtained by reversing the left/right side of the graph shown in FIG. 11 at the center of the radius position, that is, making the axial symmetry of it by assuming a line parallel to the vertical axis at the radius position. The relationship between the position whose skew angle is 0 degree and the storage capacity of the device can be obtained by reversing the inclination of the graph shown in FIG. 12, that is, its inclination becomes negative. Thus, in the characteristic shown in FIG. 9, the position in the radius direction, whose skew angle is 0 degree can be made within a third of an area extended from the innermost circumference toward the outside of the magnetic disk 33.

Although in this preferred embodiment, the surface shape of the main pole 61a is trapezoidal, the surface shape can also contain a trapezoid. For example, the inclination of a side forming the taper angle a can change on the way.

What is claimed is:

1. A magnetic head provided with a main pole for recording data on a rotary magnetic disk, wherein
a surface of a main pole, facing a magnetic disk has a rectangle-shaped part whose width in a radius direction consecutively changes in a direction orthogonal to the radius direction of the magnetic disk,
the rectangular part has two sides facing each other in the orthogonal direction, and two angles formed by one of the two sides and two sides touching the side are different, and one of the two angles is in neighborhood of 90 degrees including 90 degrees.

2. The magnetic head according to claim 1, wherein
the rectangle-shaped is a trapezoid, two sides facing each other in the orthogonal direction of which are parallel.

3. The magnetic head according to claim 1, wherein
an angle in the neighborhood is formed by a side located inside in the radius direction.

4. The magnetic head according to claim 2, wherein
the entire surface of the main pole is the trapezoid-shaped.

5. A magnetic head provided with a main pole for recording data on a rotary magnetic disk, wherein
a surface of a main pole, facing a magnetic disk has a trapezoid-shaped part in which two sides facing each other in a direction orthogonal to a radius direction of the magnetic disk are parallel,
the trapezoid-shaped part has a base, which is shorter one of the two sides, and there is a size relationship between two angles formed by the base and two sides touching the base that an angle formed by a side located outside in the radius direction is smaller than an angle formed by a side located inside in the radius direction.

6. The magnetic head according to claim 5, wherein
an angle formed by the side located inside is in the neighborhood of 90 degrees including 90 degrees.

7. The magnetic head according to claim 5, wherein
the entire surface of the main pole is the trapezoid-shaped.

8. A magnetic head provided with a main pole for recording data on a rotary magnetic disk, wherein
a surface of a main pole, facing a magnetic disk has a trapezoid-shaped part in which two sides facing each other in a direction orthogonal to a radius direction of the magnetic disk are parallel,
the trapezoid-shaped part has a base, which is the shorter one of the two sides, and one of two angles formed by the base and two sides touching the base is in the neighborhood of 90 degrees including 90 degrees.

9. The magnetic head according to claim 8, wherein
the entire surface of the main pole is the trapezoid-shaped.

10. A magnetic disk device for recording data on a rotary magnetic disk, comprising:
a magnetic head with a main pole for recording data; and
a moving unit for moving the magnetic head in a radius direction of the magnetic disk,
wherein
a position in the radius direction of the magnetic head, whose skew angle, which is formed by a direction orthogonal to the radius direction of the magnetic disk, is 0 degree, is within a third of an area extended from the outermost circumference toward a center, of the magnetic disk.

11. The magnetic disk device according to claim 10, wherein
any of the magnetic heads set forth in claims 1, 5 and 8 is adopted as the magnetic head.

12. The magnetic disk device according to claim 10, wherein
the third of an area extended from the outermost circumference toward a center, of the magnetic disk is a third of an area for writing data, extended from an outermost circumference of a range in the radius direction to an innermost circumference of the range.

13. The magnetic disk device according to claim 10, wherein
the third of an area extended from the outermost circumference toward a center, of the magnetic disk is an area in which the number of recording tracks for writing data, counted from an outermost circumference is a third of the total number.

14. The magnetic disk device according to claim 10, wherein
the position in the radius direction of the magnetic disk, whose skew angle is 0 degree is made within a third of an area extended from an outermost circumference toward a center, of the magnetic disk by forming a suspension arm from a motor of the moving unit up to a position where the magnetic head is mounted in a folded shape.
